(19) United States
(12) Patent Application Publication
(10) Pub. No.: US 2024/0424935 A1
(43) Pub. Date: Dec. 26, 2024

(54) CHARGING SYSTEM FOR ELECTRIC WORK VEHICLES AND ASSOCIATED METHODS

(71) Applicant: CNH Industrial America LLC, New Holland, PA (US)

(72) Inventor: Kelly Michael Burgess, Dannebrog (NE)

(21) Appl. No.: 18/752,255

(22) Filed: Jun. 24, 2024

Related U.S. Application Data
(60) Provisional application No. 63/522,817, filed on Jun. 23, 2023.

(51) Int. Cl. B60L 53/54; H01M 8/04298; H01M 16/00

(52) U.S. Cl. CPC B60L 53/54; H01M 8/04298; H01M 16/006; B60L 2200/40; H01M 2220/20; H01M 2250/20

(57) ABSTRACT

A charging system for electric work vehicles, such as electric agricultural vehicles or electric construction vehicles, allows for more efficient and cost-effective charging of electric work vehicles at a work site. For example, the charging system may use electricity available at staging site to generate hydrogen for subsequent use in generating electricity at the work site. Additionally, the charging system may facilitate communication between the various components of the charging system to ensure efficient and cost-effective charging of the electric work vehicles.

### FIELD OF THE INVENTION

The present disclosure generally relates to electric work vehicles and, more particularly, to charging systems for electric work vehicles, such as electric agricultural or construction vehicles, and associated methods.

### BACKGROUND OF THE INVENTION

Electric work vehicles, such as electric agricultural vehicles and electric construction vehicles, typically include an electric power source, such as a battery, and various electric power consuming components, such as one or more electric motors. In addition, an electric work vehicle must be equipped various other electric-vehicle-related components, such as a motor/inverter controller and an associated power inverter for converting the DC power available from the battery into usable power for driving the electric motor(s).

During operation of electric work vehicles, it may be necessary to charge the batteries of such vehicles to maintain their operability. In this respect, various charging systems have been developed. However, further improvements are needed. For example, many current electric vehicle charging systems rely on electricity taken directly from the power grid. Such systems can be impractical at many work sites, such as agricultural fields and remote construction sites, as power from the grid is not available is generally unavailable. Conventional charging systems that can operate without a direct connection to the power grid rely on diesel-powered generators. However, electricity generated by diesel generators is expensive and not environmentally friendly.

Accordingly, an improved charging system for electric work vehicles would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a charging system configured in accordance with one or more of the embodiments described herein.

In another aspect, the present subject matter is directed to a method for charging electric work vehicles in accordance with one or more of the embodiments described herein.

In a further aspect, the present subject matter is directed to an electric work vehicle configured to communicate with and be charged by a charging system in accordance with one or more of the embodiments described herein.

Additionally, in one aspect, the present subject matter is directed to a charging trailer for charging electric vehicles at a work site using hydrogen in accordance with one or more of the embodiments described herein.

Moreover, in a further aspect, the present subject matter is directed to a charging system. The charging system includes a charging trailer having a fuel cell configured to generate electricity from received hydrogen and a charger configured to charge a battery of an electric work vehicle using the electricity generated by the fuel cell. Additionally, the charging system includes a computing system configured to control the operation of the fuel cell based at least in part on a charging status of the electric work vehicle.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of an electric work vehicle in accordance with aspects of the present subject matter;

FIG. 2 illustrates a diagrammatic view of one embodiment of a system for charging electric work vehicles in accordance with aspects of the present subject matter;

FIG. 3 illustrates a schematic view of one embodiment of the system for charging electric work vehicles shown in FIG. 2; and

FIG. 4 illustrates a flow diagram of one embodiment of a method for charging electric work vehicles in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system for charging electric work vehicles, such as electric agricultural vehicles and/or electric construction vehicles, and associated methods of use. In several embodiments, the disclosed system may include various components to facilitate charging of electric work vehicles, such as an electrolyzer(s), a hydrogen storage device(s), and a charging trailer having a fuel cell(s) and a charger(s). Additionally, such components may communicate with each other and with one or more electric work vehicles and/or transport vehicles to ensure that the work vehicle(s) remains charged during operations at a work site in an efficient and cost-effective manner. Various embodiments of the charging system associated components, vehicles, and methods will generally be described below.

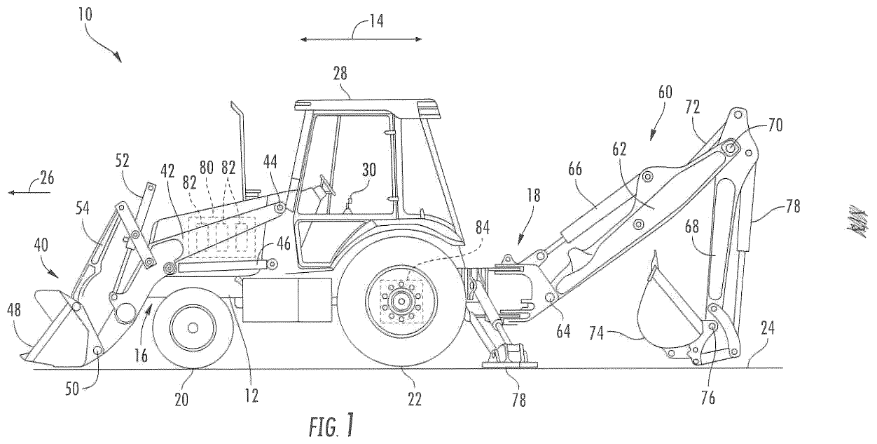

Referring now to the drawings, FIG. 1 illustrates a side view of one embodiment of an electric work vehicle 10 in accordance with aspects of the present subject matter. As shown, the electric work vehicle 10 is configured as an electric construction vehicle, such as the illustrated tractor-loader-backhoe (TLB). However, in other embodiments, the electric work vehicle 10 may be configured as an electric agricultural vehicle (e.g., an electric tractor).

As shown in FIG. 1, the electric work vehicle 10 includes a frame or chassis 12 extending in a longitudinal direction (indicated by arrow 14 in FIG. 1) of the vehicle 10 between a forward end 16 of the chassis 12 and an aft end 18 of the chassis 12. In general, the chassis 12 may be configured to support or couple to a plurality of components. For example, a pair of steerable front traction devices (e.g., front wheels 20 (one of which is shown)) and a pair of driven rear traction devices (e.g., rear wheels 22 (one of which is shown)) may be coupled to the chassis 12. The wheels 20, 22 may be configured to support the electric work vehicle 10 relative to a ground surface 24 and move the electric work vehicle 10 along the ground surface 24 in a direction of travel, such as a forward direction of travel (e.g., as indicated by arrow 26 in FIG. 1). However, in alternative embodiments, the front wheels 20 may be driven in addition to or in lieu of the rear wheels 22. Additionally, an operator's cab 28 may be supported by a portion of the chassis 12 positioned between the forward and aft ends 16, 18 of the chassis 12, and may house one or more operator control devices 30 (e.g., a joystick(s), a lever(s), and/or the like) for permitting an operator to control the operation of the electric work vehicle 10.

The electric work vehicle 10 also includes a pair of hydraulically-driven work implement assemblies positioned at the opposed ends 16, 18 of the chassis 12. Specifically, in the illustrated embodiment, the electric work vehicle 10 includes a loader assembly 40 supported by or relative to the chassis 12 at or adjacent to its forward end 16. As shown in FIG. 1, the loader assembly 40 includes a loader arm 42 pivotably coupled or supported relative to the chassis 12 at a loader arm pivot point 44, and a loader lift cylinder 46 secured between the loader arm 42 and the chassis 12. In such an embodiment, extension/retraction of the loader lift cylinder 46 may result in the loader arm 42 pivoting upwards/downwards about its respective pivot point 44, thereby allowing the positioning of the loader arm 42 relative to both the chassis 12 and the ground surface 24 to be adjusted, as desired. Moreover, as shown in FIG. 1, the loader assembly 40 further includes a first work implement 48, such as a loader bucket, coupled to the loader arm 42 at an implement pivot point 50, and a first implement tilt cylinder 52 secured between the work implement 48 (e.g., via a linkage(s) 54) and a portion of the loader arm 44. As such, extension/retraction of the first implement tilt cylinder 52 may result in the first work implement 48 pivoting upwards/downwards relative to the loader arm 42 about its respective pivot point 50, thereby permitting the tilt angle or orientation of the implement 48 to be adjusted, as desired. Thus, by controlling the operation of the lift and tilt cylinders 46, 52 of the loader assembly 40, the vertical positioning and orientation of the first work implement 48 may be adjusted to allow for the execution of one or more operations, such as one or more material-moving operations.

Additionally, the electric work vehicle 10 includes a backhoe assembly 60 supported by or relative to the chassis 12 at or adjacent to its aft end 18. As shown in FIG. 1, the backhoe assembly 60 includes a boom 62 pivotably coupled or supported relative to the chassis 12 at a boom pivot point 64, and a boom lift cylinder 66 secured between the boom 62 and the chassis 12. In such an embodiment, extension/retraction of the boom cylinder 66 may result in the boom 62 pivoting upwards/downwards about its respective pivot point 64, thereby allowing the positioning of the boom 62 relative to both the chassis 12 and the ground surface 24 to be adjusted, as desired. The backhoe assembly 60 also includes a dipper arm 68 coupled to the boom 62 at a dipper pivot point 70, and a dipper cylinder 72 secured between the dipper arm 68 and the boom 62. In such an embodiment, extension/retraction of the dipper cylinder 72 may result in the dipper arm 68 pivoting upwards/downwards about its respective pivot point 70 relative to the boom 62. Moreover, as shown in FIG. 1, the backhoe assembly 60 further includes a second work implement 74, such as a dipper bucket, coupled to the dipper arm 68 at an implement pivot point 76, and a second implement tilt cylinder 78 secured between the work implement 74 and a portion of the dipper arm 68. As such, extension/retraction of the second implement tilt cylinder 78 may result in the second work implement 74 pivoting upwards/downwards relative to the dipper arm 68 about its respective pivot point 76, thereby permitting the tilt angle or orientation of the implement 74 to be adjusted, as desired. Thus, by controlling the operation of the various cylinders 66, 72, 78 of the backhoe assembly 60, the vertical positioning and orientation of the second work implement 74 may be adjusted to allow for the execution of one or more operations, such as one or more material excavation operations.

As shown in FIG. 1, the electric work vehicle 10 may also include a pair of stabilizer legs 78 (one of which is shown) positioned at or adjacent to the aft end 18 of the chassis 12. The stabilizer legs 78 may be configured to support the weight of the electric work vehicle 10 and/or otherwise stabilize the loader 10 during the performance of a backhoe-related operation. For instance, the stabilizer legs 78 may be pivotably coupled to the chassis 12 to allow the legs 78 to be moved or pivoted (e.g., via the operation of an associated stabilizer leg cylinder 78) between a lowered position, at which the legs 78 contact the ground surface 24, and a raised position, at which the legs 78 are lifted off the ground surface 24 to allow movement of the electric work vehicle 10 (e.g., in the forward direction of travel 26). In addition to lowering the stabilizer legs 78, the loader assembly 40 may also be lowered during the performance of a backhoe-related operation such that the first work implement 48 contacts the ground, thereby providing a point-of-contact to stabilize the front end 16 of the chassis 12.

Furthermore, the electric work vehicle 10 may include an electric drivetrain configured to propel the loader 10 in the direction of the travel 26. For example, in the illustrated embodiment, the electric drivetrain includes a power storage device, such as a battery module 80 having three batteries 82, supported on and positioned adjacent to the forward end 16 of the chassis 12. Moreover, in the illustrated embodiment, the electric drivetrain includes a pair of electric traction motors 84 (one of which is shown) supported on the chassis 12, with each motor 84 coupled to one of the driven wheels 22 via a suitable shaft (not shown). More specifically, the batteries 82 may be configured to provide electric power for use in powering the electric traction motors 84 and other power-consuming components of the electric work vehicle 10. Each electric traction motor 84 may, in turn, rotationally drive the corresponding rear wheel 22, thereby propelling the electric work vehicle 10 in the forward direction of travel 26. However, in alternative embodiments, the electric drivetrain of the electric work vehicle 10 may have any other suitable configuration. For example, in one embodiment, the electric work vehicle 10 may include as a single electric traction motor coupled to a transmission (not shown) that transmits the torque generated by the electric traction motor to each of the rear wheels 22. In another embodiment, the electric work vehicle 10 may include an electric traction motor coupled to each of the wheels 20, 22. Furthermore, the battery module 80 may include any other suitable number of batteries 82.

In addition, the electric work vehicle 10 may include various components for controlling the operation of the electric drivetrain. For instance, although not shown, one or more power inverters may be coupled to the battery module 80 via a direct current (DC) voltage bus or any other suitable electrical coupling for converting the direct current supplied by the batteries 82 of the battery module 80 to an alternating current (AC) for powering the electric traction motors 84 and the electric hydraulics-driving motor 102. An associated motor/inverter controller(s) may control the operation of the power inverter(s) in a manner that drives each electric motor 84, 102 as desired, such as by ensuring that each motor 84, 102 is driven to achieve a desired speed and/or torque output.

The configuration of the electric work vehicle 10 described above and shown in FIG. 1 is provided only to place the present subject matter in an exemplary field of use. Thus, the present subject matter may be readily adaptable to any manner of electric vehicle configuration, such as any other suitable type of electric construction vehicle and/or a suitable electric agricultural vehicle.

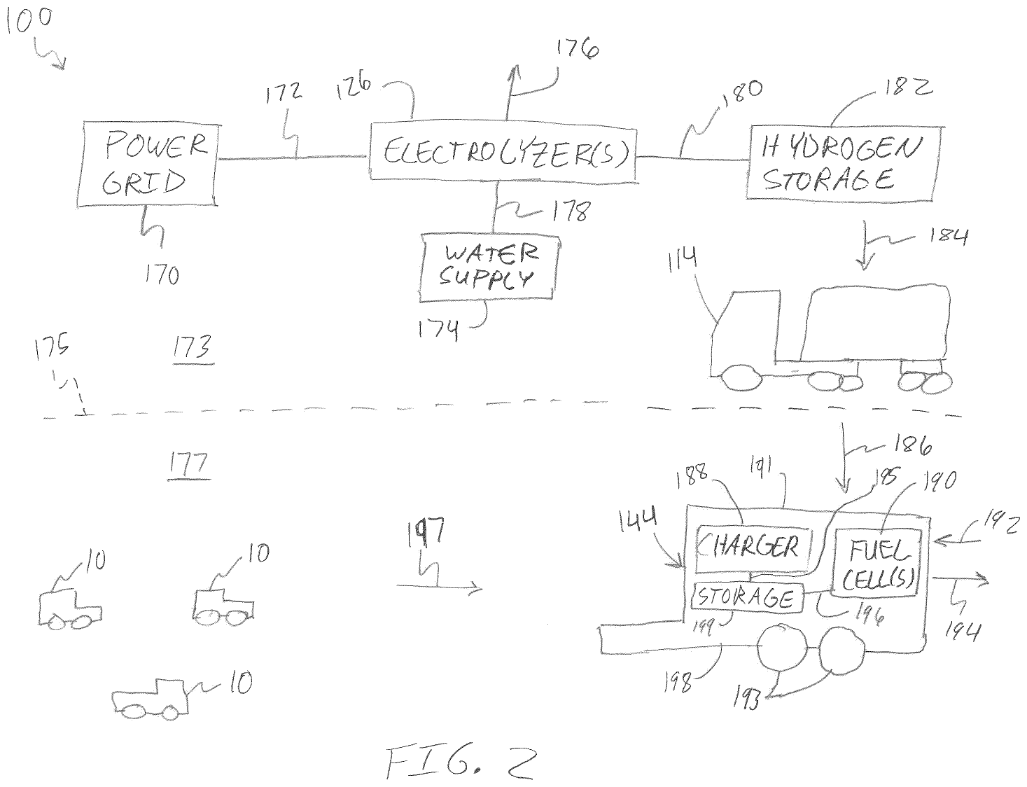

Referring now to FIG. 2, a diagrammatic view of one embodiment of a system 100 for charging electric work vehicles is illustrated in accordance with aspects of the present subject matter. In general, the charging system 100 will be described herein with reference to the electric work vehicle 10 described above with reference to FIG. 1. However, it should be appreciated by those of ordinary skill in the art that the disclosed system 100 may generally be utilized with electric work vehicles having any other suitable vehicle configuration.

As shown in FIG. 2, the charging system 100 may include one or more electrolyzers 126. In general, the electrolyzer(s) 126 is configured to generate hydrogen using electricity and water. As will be described below, the hydrogen generated by the electrolyzer(s) 126 will eventually be used to generate electricity for charging one or more electric work vehicles 10. Specifically, in several embodiments, the electrolyzer(s) 126 is configured to receive electricity from a power grid 170, such as via power line(s) 172. Such electric power is typically available at a lower cost than electricity generated by diesel generators. In some embodiments, the power grid 170 is at least partially powered by a renewable energy source(s) (e.g., solar cells, wind turbines, etc.). The electrolyzer(s) 126 may also receive water, such as from a water source 174 (e.g., a municipal water supply) via a pipe(s) 178. Thereafter, the electrolyzer(s) 126 converts the received electricity and water into hydrogen and oxygen. As will be described below, the hydrogen will be stored for subsequent use. The generated oxygen may be exhausted into the atmosphere as indicated by arrow 176.

Furthermore, the charging system 100 includes a hydrogen storage device 182. In general, the hydrogen storage device 182 is configured to receive the hydrogen generated by the electrolyzer(s) 126, such as via a pipe(s) 180, and store such received hydrogen for subsequent use. For example, in some embodiments, the hydrogen storage device 182 may include one or more tanks or other pressure vessels into which the hydrogen can be pumped for storage.

In several embodiments, the electrolyzer(s) 126 and the hydrogen storage device 182 are located at a staging site 173, while the electric work vehicle(s) 10 is located at a work site 177 (for illustrative purposes, the stage site 173 and the work site 177 are separated by dashed line 175 in FIG. 2). In general, the staging site 172 corresponds to any suitable location at which electricity from a power grid is readily available. For example, in the context of an agricultural operation, the staging site 172 may be a farmyard or other area where the electric agricultural vehicles are staged, stored, and/or maintained. In the context of a construction operation, the staging site 172 may an area where the electric work vehicle(s) 10 are staged, stored, and/or maintained. Conversely, the work site 177 corresponds to any area at which an agricultural or construction operation is to be performed and electricity from a power grid is not readily available. For example, the work site 177 may be an agricultural field, a remote construction site (e.g., a construction site at which electricity is not yet available), or the like. Thus, the staging site 173 and the staging site 177 are generally physically and geographically separated, sometimes by a significant distance.

Moreover, the charging system 100 may include one or more transport vehicles 114. In general, the transport vehicle(s) 114 is any suitable vehicle(s) configured to transport hydrogen from the hydrogen storage device 182 to the work site 177. For example, in one embodiment, the transport vehicle(s) 114 may correspond to a tanker truck(s) having a suitable tank(s) for transporting hydrogen. Thus, hydrogen stored in the hydrogen storage device 182 may be pumped into the tank(s) of the transport vehicle(s) 114. Thereafter, the transport vehicle(s) 114 may transport or otherwise convey hydrogen from the hydrogen storage device 182 to the work site 177.

In addition, the charging system 100 includes a charging trailer 144. As will be described below, the charging trailer 144 may be configured to generate electricity for charging the electric work vehicle(s) 10 using hydrogen received from the transport vehicle(s) 114. In general, the charging trailer 144 is a mobile device that can be transported to the work site 177 for use in charging the electric work vehicle(s) 10 present at the work site 177. For example, in the illustrated embodiment, the charging trailer 144 includes a frame 198 configured to support one or more components of the charging trailer 144. Moreover, the charging trailer 144 may include a plurality of wheels 193 configured to support the frame 198 relative to the surface of the work site 177 and a facilitate movement of the charging trailer 144, such as to and from the work site 177. Additionally, the charging trailer 144 may include an enclosure 191 supported on the frame 198 and configured to house or otherwise enclose one or more components of the charging trailer 144, such as to protect such component(s) from the environment. However, in alternative embodiments, the charging trailer 144 may have any other suitable configuration.

In several embodiments, the charging trailer 144 may include one or more fuel cell(s) 190 supported on the frame 198 and positioned within the enclosure 191. In general, the fuel cell(s) 190 is configured to generate electricity using hydrogen and oxygen. As will be described below, the electricity generated by the fuel cell(s) 190 will eventually be used to charge one or more electric work vehicles 10 at the work site 177. Specifically, in several embodiments, the fuel cell(s) 190 is configured to receive hydrogen from the transport vehicle(s) 114 as indicated by arrow 182 in FIG. 2. Such hydrogen may be stored in a tank(s) (not shown) of the charging trailer 144 between delivery by the transport vehicle(s) 114 and use by the fuel cell(s) 190. Moreover, the fuel cell(s) 190 may also receive oxygen, such as from the atmosphere as indicated by arrow 192 in FIG. 2. Thereafter, the fuel cell(s) 190 converts the received hydrogen and oxygen into electricity and water. The generated electricity may be supplied to a energy storage device 199, such as a battery(ies), via electrical wiring 196 for storage. The generated water may be discharged from the charging trailer 144 as indicated by arrow 194 in FIG. 2.

Furthermore, the charging trailer 144 includes a charger 188 supported on the frame 198 and positioned within the enclosure 191. In general, the charger 188 is configured to receive electricity from the energy storage device 199 via the electrical wire(s) 195 and supply the electricity (e.g., DC power) to an electric work vehicle 10 that has been coupled to the charger 199. For example, the charger 144 may be any suitable type of device configured to charge the battery(ies) 82 of the electric work vehicle 10, such as a DC fast charger. In this respect, when one of the electric work vehicles 10 moves to a position adjacent to the charging trailer 144 (e.g., as indicated by arrow 197) and is electrically coupled to the charging trailer 144 (e.g., via a charging cable (not shown)), the charger 188 supplies electricity (e.g., DC power) from the energy storage device 199 to the battery(ies) 82 of the work vehicle 10.

As will be described below, the various components of the charging system 100 are configured to communicate with each other to ensure that the electric work vehicle(s) 10 present at the work site 177 remains charged during operations at the work site 177 in an efficient and cost-effective manner. For example, in some embodiments, the electrolyzer(s) 126, the hydrogen storage device 182, the transport vehicle(s) 114, the charging trailer 144, and the electric work vehicle(s) 10 all communicate to ensure that the electrolyzer(s) 126 produce sufficient hydrogen, the transport vehicle(s) 114 deliver sufficient hydrogen to the charging trailer 144, the charging trailer 144 produces sufficient electricity to charge the electric work vehicle(s) 10 and the electric work vehicle(s) 10 are charged in an efficient and cost-effective manner. Thus, the charging system 100 may use the location(s) of the electric work vehicle(s) 10, the location of the charging trailer 144, the cost electricity from the power grid 170, the amount of hydrogen stored within the hydrogen storage device 182, the distance between the staging site 173 and the work site 177, the amount of charge or electricity stored within the energy storage device 199 of the charging trailer 144, and/or other parameters to determine when to produce additional hydrogen via the electrolyzer(s) 126, when to transport hydrogen to the charging trailer 144 via the transport vehicle(s) 144, when to produce electricity via the fuel cell(s) 190, when to move the electric work vehicle(s) 10 to the charging trailer 144 for charging, and/or the route(s) to be used to move the electric work vehicle(s) 10 to the charging trailer 144.

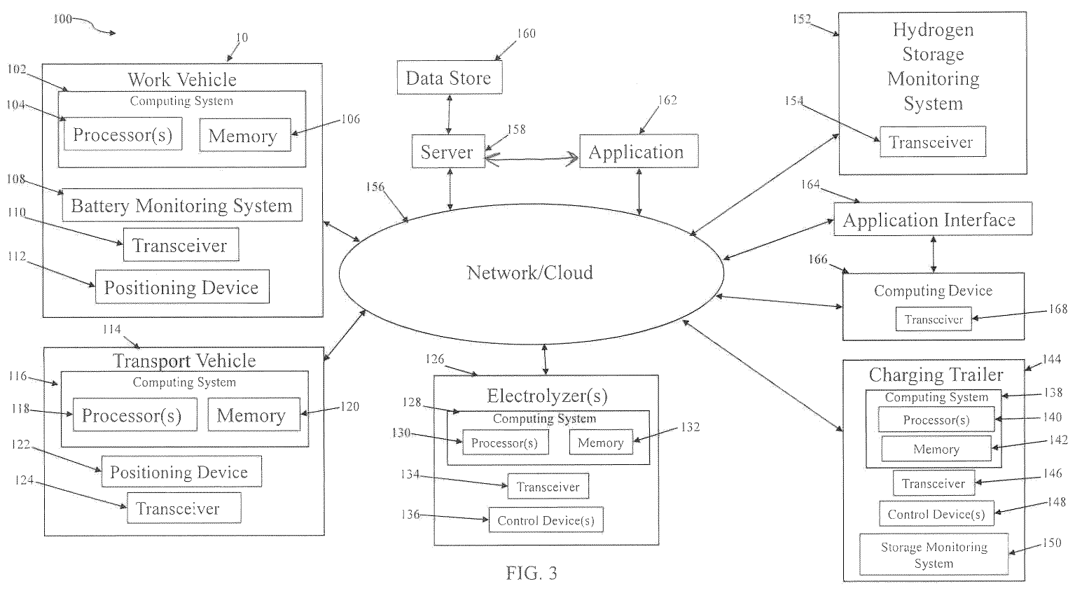

FIG. 3 illustrates a schematic view of one embodiment of a charging system 100 for charging electric work vehicles is illustrated in accordance with aspects of the present subject matter. As mentioned above, in several embodiments, the charging system 100 may include one or more electric work vehicle 10. For example, the electric work vehicle 10 may correspond to an electric agricultural vehicle (e.g., an electric tractor) or an electric construction vehicle (e.g., the electric TLB shown in FIG. 1). Although only one electric work vehicle 10 is shown in FIG. 3 for purposes of clarity, the charging system 100 may include or otherwise be used in association with any suitable number of electric work vehicles 10, such as two or more electric work vehicles 10.

In several embodiments, the electric work vehicle 10 may include a battery monitoring system 108. In general, the battery monitoring system 108 is configured to monitor the charge status of the battery module 80 of the electric work vehicle 10. As such, the battery monitoring system 108 may include any suitable sensor(s) or sensing device(s) configured to generate data indicative of the charging status of the battery module 80, such as the voltage of the batteries 82, the current power draw from the batteries 80, the temperature of the batteries 82, and/or the like. Based on such data, the charging status of the battery module 80 of the electric work vehicle 10 present at the work site 177 may be determined or estimated.

The electric work vehicle 10 may also include a computing system 102 that may be operably coupled with the battery monitoring system 108. In general, the computing system 102 may correspond to any suitable processor-based device(s), such as a computing device or any combination of computing devices. Thus, as shown in FIG. 3, the computing system 102 may generally include one or more processor(s) 104 and associated memory devices 106 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 106 may generally comprise memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store information accessible to the processor(s) 104, including data that can be retrieved, manipulated, created, and/or stored by the processor(s) 104 and instructions that can be executed by the processor(s) 104.

In operation, the battery monitoring system 108 may generate data indicative of the charging status of the electric work vehicle. The computing system 102 may receive the battery module charge status data from the battery monitoring system 108. The computing system 102 may then determine one or more charge status parameters associated with the charge status or the available remaining charge of the electric work vehicle 10, such as the voltage of the battery(ies) 82, the current draw from the battery(ies) 80, the temperature of the battery(ies) 82, and/or the like.

In some embodiments, the electric work vehicle 10 may be provided with a positioning device 112 (e.g., a GPS device) that tracks the location of the electric work vehicle 10. For example, in some embodiments, the positioning device 112 may be configured to determine the location of the electric work vehicle 10 using a satellite navigation position system (e.g., a GPS system, a Galileo positioning system, the Global Navigation satellite system (GLONASS), the BeiDou Satellite Navigation and Positioning system, and/or the like). In such an embodiment, position data may be collected during the work operation (e.g., the agricultural operation or construction operation), such as by being recorded or stored within the memory 106 of the onboard computing system 102 of the electric work vehicle 10, that is associated with the location/coordinates of each path across a field. In addition, the computing system 102 may also include various other suitable components, such as a communications circuit or module, one or more input/output channels, a data/control bus, and/or the like.

Additionally, as mentioned above, in several embodiments, the charging system 100 may include one or more transport vehicles 114. Although only one transport vehicle 114 is shown in FIG. 3 for purposes of clarity, the charging system 100 may include or otherwise be used in connection with any suitable number of transport vehicle 114, such as two or more transport vehicle 114.

In some examples, the transport vehicle 114 can further include a computing system 116. The computing system 116 may correspond to any suitable processor-based device(s), such as a computing device or any combination of computing devices. Thus, as shown in FIG. 3, the computing system 116 may generally include one or more processor(s) 118 and associated memory devices 120 configured to perform a variety of computer-implemented functions (e.g., performing the methods, steps, algorithms, calculations, and the like disclosed herein). The memory 120 may generally be configured to store information accessible to the processor(s) 118, including data that can be retrieved, manipulated, created, and/or stored by the processor(s) 118 and instructions that can be executed by the processor(s) 118. In addition, the computing system 116 may also include various other suitable components, such as a communications circuit or module, one or more input/output channels, a data/control bus, and/or the like.

In some embodiments, the transport vehicle 114 may be provided with a positioning device 122 (e.g., a GPS device) that tracks the location of the transport vehicle 114. For example, in some embodiments, the positioning device 122 may be configured to determine the location of the transport vehicle 114 using a satellite navigation position system (e.g. a GPS system, a Galileo positioning system, the Global Navigation satellite system (GLONASS), the BeiDou Satellite Navigation and Positioning system, and/or the like). In such an embodiment, position data may be collected during the work operation (e.g., the agricultural operation or construction operation), such as by being recorded or stored within the memory 120 of the onboard computing system 116 of the transport vehicle 114, that is associated with the location/coordinates of each path across a field. In addition, the computing system 116 may also include various other suitable components, such as a communications circuit or module, one or more input/output channels, a data/control bus, and/or the like.

Furthermore, as mentioned above, in several embodiments, the charging system 100 may include the electrolyzer(s) 126. In some examples, the electrolyzer(s) 126 can further include a computing system 128. The computing system 128 may correspond to any suitable processor-based device(s), such as a computing device or any combination of computing devices. Thus, as shown in FIG. 3, the computing system 128 may generally include one or more processor(s) 130 and associated memory devices 132 configured to perform a variety of computer-implemented functions (e.g., performing the methods, steps, algorithms, calculations, and the like disclosed herein). The memory 132 may generally be configured to store information accessible to the processor(s) 130, including data that can be retrieved, manipulated, created, and/or stored by the processor(s) 130 and instructions that can be executed by the processor(s) 130. In addition, the computing system 128 may also include various other suitable components, such as a communications circuit or module, one or more input/output channels, a data/control bus, and/or the like.

In some embodiments, the electrolyzer(s) 126 may include one or more control device(s) 136. Specifically, the control device(s) 136 may correspond to an actuator(s) configured to control operation of electrolyzer(s) 126. For example, the control device(s) 136 may include a switch(es) configured to initiate, halt, or adjust the flow of electricity from the power grid 170 to the electrolyzer(s) 126, a valve(s) configured to configured to initiate, halt, or adjust the flow of water from the water supply 174 to the electrolyzer(s) 126, and/or any other actuator(s) or other component(s) that can initiate, halt, or adjust the operation of the electrolyzer(s) 126. As will be described below, the computing system 128 may be configured to control the operation of the control device(s) 136 such that the electrolyzer(s) 126 generates a selected or desired amount of hydrogen.

Additionally, as mentioned above, in several embodiments, the charging system 100 may include the charging trailer 144. In some examples, the charging trailer 144 can further include a computing system 138. The computing system 138 may correspond to any suitable processor-based device(s), such as a computing device or any combination of computing devices. Thus, as shown in FIG. 3, the computing system 138 may generally include one or more processor(s) 140 and associated memory devices 142 configured to perform a variety of computer-implemented functions (e.g., performing the methods, steps, algorithms, calculations, and the like disclosed herein). The memory 142 may generally be configured to store information accessible to the processor(s) 140, including data that can be retrieved, manipulated, created, and/or stored by the processor(s) 140 and instructions that can be executed by the processor(s) 140. In addition, the computing system 138 may also include various other suitable components, such as a communications circuit or module, one or more input/output channels, a data/control bus, and/or the like.

In some embodiments, the charging trailer 144 may include one or more control device(s) 148. Specifically, the control device(s) 148 may correspond to an actuator(s) configured to control operation of one or more components of the charging trailer 144, such as the fuel cell(s) 190, the energy storage device 199, and/or the charger 188. For example, the control device(s) 148 may include a switch(es) configured to initiate, halt, or adjust the flow of electricity from the energy storage device 199 to the charger 188, a valve(s) configured to configured to initiate, halt, or adjust the flow of hydrogen and/or oxygen to the fuel cell(s) 190, and/or any other actuator(s) or other component(s) that can initiate, halt, or adjust the operation of the fuel cell(s) 190, the energy storage device 199, and/or the charger 188. As will be described below, the computing system 138 may be configured to control the operation of the control device(s) 148 such that the fuel cell(s) 190 generates a selected or desired amount of electricity.

Moreover, in some embodiments, the charging trailer 144 may include an energy storage device monitoring system 150. In general, the energy storage device monitoring system 150 is configured to monitor the charge status of the energy storage device 198 of the charge trailer 144. As such, the energy storage device monitoring system 150 may include any suitable sensor(s) or sensing device(s) configured to generate data indicative of the charging status of the energy storage device 199, such as the voltage of the energy storage device 199, the current draw from the energy storage device 199, the temperature of the energy storage device 199, and/or the like. Based on such data, the charging status of the energy storage device 199 of the charging trailer 144 present at the work site 177 may be determined or estimated.

In addition, in several embodiments, the charging system 100 may a hydrogen storage monitoring system 152 provided in operative association with the hydrogen storage device 182. In general, the hydrogen storage monitoring system 152 is configured to monitor the fill status of or the amount or volume of hydrogen being stored within the hydrogen storage device 182. As such, the hydrogen storage monitoring system 152 may include any suitable sensor(s) or sensing device(s) configured to generate data indicative of the fill status of or the amount/volume of hydrogen being stored within the hydrogen storage device 182, such as the weight or volume of hydrogen being stored within the hydrogen storage device 182. Based on such data, the fill status of the hydrogen storage device 182 may be determined or estimated.

In some examples, the electric work vehicle 10, the transport vehicle 114, the electrolyzer(s) 126, the charging trailer 144, and/or the hydrogen storage monitoring system 152 may be communicatively coupled with one or more remote sites, such as a remote server 152 via a network/cloud 156 to provide data and/or other information therebetween through respective transceivers 110, 124, 134, 146, 154. The network/cloud 156 represents one or more systems by which the electric work vehicle 10, the transport vehicle 114, the electrolyzer(s) 126, the charging trailer 144, and/or the hydrogen storage monitoring system 152 may communicate with the remote server 158. The network/cloud 152 may be one or more of various wired or wireless communication mechanisms, including any desired combination of wired and/or wireless communication mechanisms and any desired network topology (or topologies when multiple communication mechanisms are utilized). Exemplary communication networks include wireless communication networks (e.g., using Bluetooth, IEEE 802.11, etc.), local area networks (LAN), and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g., 156 in FIG. 3). The verbal illustration has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 156.

The server 158 may be one or more computer servers, each of which may include at least one processor and at least one memory, the memory storing instructions executable by the processor, including instructions for carrying out various steps and processes. The server 158 may include or be communicatively coupled to a data store 160 for storing collected data as well as instructions for the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 with or without intervention from a user, the electric work vehicle 10, the transport vehicle 114, the electrolyzer(s) 126, the charging trailer 144, and/or the hydrogen storage monitoring system 152. Moreover, the server 158 may be capable of analyzing initial or raw sensor data received from the electric work vehicle 10, the transport vehicle 114, the electrolyzer(s) 126, the charging trailer 144, and/or the hydrogen storage monitoring system 152 and final or post-processing data (as well as any intermediate data created during data processing). Accordingly, the instructions provided to any one or more of the electric work vehicle 10, the transport vehicle 114, the electrolyzer(s) 126, the charging trailer 144, and/or the hydrogen storage monitoring system 152 may be determined and generated by the server 158 and/or one or more cloud-based applications 162.

With further reference to FIG. 3, the server 158 can also generally implement features that may enable the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 to communicate with cloud-based applications 162. Communications from the hydrogen storage monitoring system 152 can be directed through the network/cloud 156 to the server 158 and/or cloud-based applications 162 with or without a networking device, such as a router and/or modem. Additionally, communications from the cloud-based applications 162, even though these communications may indicate one of the electric work vehicle 10, the transport vehicle 114, the electrolyzer(s) 126, the charging trailer 144, and/or the hydrogen storage monitoring system 152 as an intended recipient, can also be directed to the server 158. The cloud-based applications 162 are generally any appropriate services or applications 162 that are accessible through any part of the network/cloud 156 and may be capable of interacting with the electric work vehicle 10, the transport vehicle 114, the electrolyzer(s) 126, the charging trailer 144, and/or the hydrogen storage monitoring system 152.

In various examples, the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 can be feature-rich with respect to communication capabilities, i.e. have built-in capabilities to access the network/cloud 156 and any of the cloud-based application 162 or can be loaded with, or programmed to have, such capabilities. The computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 can also access any part of the network/cloud 156 through industry-standard wired or wireless access points, cell phone cells, or network nodes. In some examples, users can register to use the remote server 158 through the electric work vehicle 10, the transport vehicle 114, the electrolyzer(s) 126, the charging trailer 144, and/or the hydrogen storage monitoring system 152, which may provide access to the electric work vehicle 10, the transport vehicle 114, the electrolyzer(s) 126, the charging trailer 144, and/or the hydrogen storage monitoring system 152 and/or thereby allow the server 158 to communicate directly or indirectly with the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152. In various instances, the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 may also communicate directly, or indirectly, with the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 or one of the cloud-based applications 162 in addition to communicating with or through the server 158. According to some examples, the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 can be preconfigured at the time of manufacture with a communication address (e.g., a URL, an IP address, etc.) for communicating with the server 158 and may or may not have the ability to upgrade or change or add to the preconfigured communication address.

Referring still to FIG. 3, when a new cloud-based application 162 is developed and introduced, the server 158 can be upgraded to be able to receive communications for the new cloud-based application 162 and to translate communications between the new protocol and the protocol used by the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152. The flexibility, scalability, and upgradeability of current server technology render the task of adding new cloud-based application protocols to the server 158 relatively quickly and easily.

In several embodiments, an application interface 164 may be operably coupled with the network/cloud 156 and/or the application 162. The application interface 164 may be configured to receive data from the battery monitoring system 108 and/or the positioning device 112 of the electric work vehicle 10, the positioning device 122 of the transport vehicle 114, the energy storage device monitoring system 150 of the charging trailer 144, and/or the hydrogen storage monitoring system 152. In various embodiments, data may also be provided from other sources, such as an operator of the electric work vehicle 10, the transport vehicle 114, the power grid 170, a company, and/or other persons that may access the application interface 164 to enter the data. Additionally, or alternatively, the data may be received from a remote server 158. For example, the data may be received in the form of software that can include one or more objects, agents, lines of code, threads, subroutines, databases, application programming interfaces (APIs), or other suitable data structures, source code (human-readable), object code (machine-readable). The application interface 164 can be implemented in hardware, software, or a suitable combination of hardware and software, and which can be one or more software systems operating on a general-purpose processor platform, a digital signal processor platform, or other suitable processors.

In some examples, at various predefined periods and/or times, the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 may communicate with the server 158 through the network/cloud 156 to obtain the stored instructions, if any exist. Upon receiving the stored instructions, the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 may implement the instructions. The server 158 may additionally store data, parameters, or information related to the operations being performed in at the work site or the staging site and/or any other location and operate and/or provide instructions to the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152 in conjunction with the stored data, parameters, or information with or without intervention from a user, the computing system 102 of the electric work vehicle 10, the computing system 116 of the transport vehicle 114, the computing system 128 of the electrolyzer(s) 126, the computing system 138 of the charging trailer 144, and/or the hydrogen storage monitoring system 152.

In some instances, a computing device 166 may also access the server 158 via a transceiver 168 to obtain data, parameters, and/or information related to the operation of the charging system 100 (e.g., related to the charging of the work vehicle 10). The computing device 182 may be a mobile device, tablet computer, laptop computer, desktop computer, watch, virtual reality device, television, monitor, or any other computing device 166 or another visual device.

As will be described below, the charging system 100 coordinates the operation of the electrolyzer(s) 126 present at the staging site (e.g., the staging site 173), the electric work vehicle(s) 100 and the charging trailer 144 present at the work site (e.g., the work site 177), and/or the transport vehicle(s) 114 moving between the staging and work sites to ensure that the electric work vehicle(s) 10 remain sufficiently charged to perform the operation on the work site in an efficient and cost effective manner. Specifically, in several embodiments, the charging system 100 use the data generated by the battery monitoring system(s) 108 of the electric work vehicle(s) 10, the data generated by the positioning device(s) 112 of the electric work vehicle(s) 10, the data generated by the positioning device(s) 122 of the transport vehicle(s) 114, data generated by the energy storage device monitoring system 150 of the charging trailer 114, and/or data generated by the hydrogen storage monitoring system 152 to facilitate such coordination. For example, based on this data, the operation of the control device(s) 136 of the electrolyzer(s) 126 may be controlled to initiate, adjust, or halt the generation of hydrogen for powering the fuel cell(s) 190 and/or the operation of the control device(s) 148 of the fuel cell(s) 190 may be controlled to initiate, adjust, or halt the generation of electricity for charging the electric work vehicle(s) 10. Additionally, based on this data, the timing when the electric work vehicle(s) 10 move to the charging trailer 144 and routes that the electric work vehicle(s) 10 take to do so may be determined. Moreover, based on this data, transportation of hydrogen from the hydrogen storage device 182 via the transport vehicle(s) 114 may be initiated.

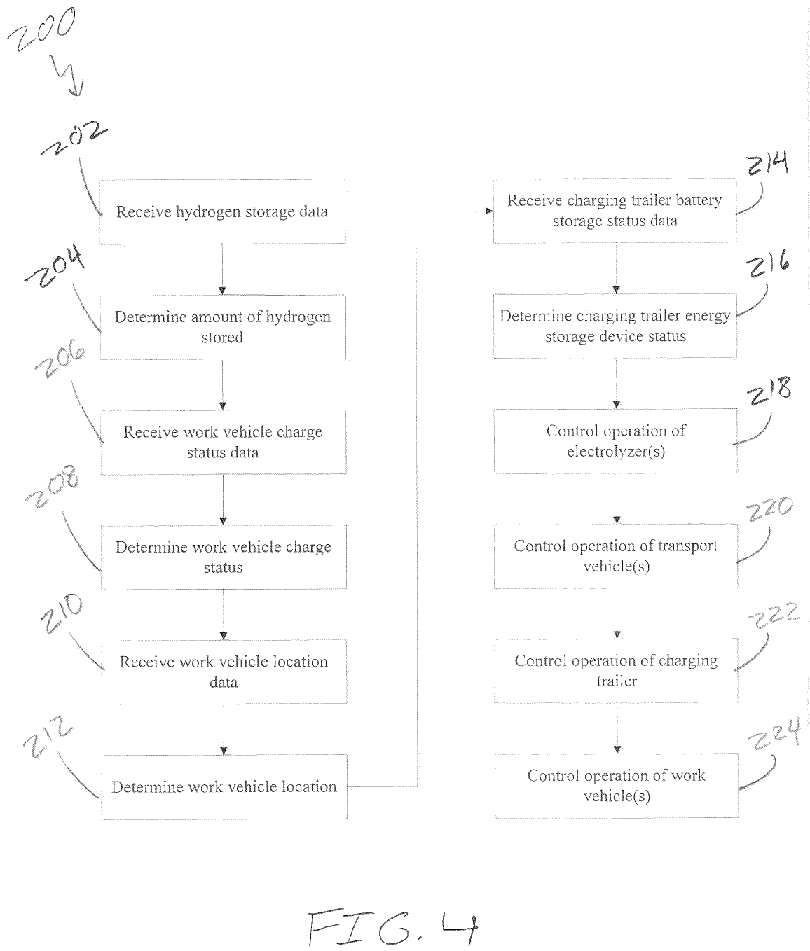

Referring now to FIG. 4, a flow diagram of one embodiment of a method 200 for charging electric vehicles is illustrated in accordance with aspects of the present subject matter. In general, the method 200 will be described herein with reference to the electric work vehicle 10 and the charging system 100 described above with reference to FIGS. 1-3. However, it should be appreciated by those of ordinary skill in the art that the disclosed method 200 may generally be implemented with any electric work vehicle having any suitable vehicle configuration and/or within any charging system having any suitable system configuration. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 4, at (202), the method 200 includes receiving hydrogen storage data. For instance, as described above, the hydrogen storage monitoring system 152 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138). In this respect, during operation of the charging system 100, such computing system(s) may receive data from hydrogen storage monitoring system 152. Such data may, in turn, be indicative of the fill status or amount/volume of hydrogen present within the hydrogen storage device 182.

Furthermore, at (204), the method 200 includes determining the amount of hydrogen being stored within the hydrogen storage device. For instance, the one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138) may analyze the data received at (202) to determine the amount or volume of hydrogen being stored within the hydrogen storage device 182. As will be described below, the determined amount/volume of hydrogen is used in coordinating the operation of one or more components of the charging system 100.

Additionally, at (206), the method 200 includes receiving electric work vehicle charge data. For instance, as described above, the battery monitoring system(s) 108 of the electric work vehicle(s) 10 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138 of the charging trailer 144). In this respect, during operation of the charging system 100, such computing system(s) may receive data from battery monitoring system(s) 108. Such data may, in turn, be indicative of the charging status of the battery module(s) 80 of the electric work vehicle(s) 10.

Moreover, at (208), the method 200 includes determining the charge status of the work vehicle(s). For instance, the one or more computing systems of the charging system 100 (e.g., the computing system 102 of the electric work vehicle 10, the computing system 116 of the transport vehicle 114, the computing system 128 of the electrolyzer(s) 126, and/or the computing system 138 of the charging trailer 144) may analyze the data received at (206) to determine charging status of the electric work vehicle(s) 10 being used at the work site (e.g., the work site 177). As will be described below, the determined charging status of the electric work vehicle(s) 10 is used in coordinating the operation of one or more components of the charging system 100.

In addition, at (210), the method 200 includes receiving electric work vehicle location data. For instance, as described above, the positioning device(s) 112 of the electric work vehicle(s) 10 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138 of the charging trailer 144). In this respect, during operation of the charging system 100, such computing system(s) may receive data from positioning device(s) 112. Such data may, in turn, be indicative of the location(s) of the electric work vehicle(s) 10 within the work site (e.g., relative to the charging trailer 144).

As shown in FIG. 4, at (212), the method 200 includes determining the location(s) of the work vehicle(s). For instance, the one or more computing systems of the charging system 100 (e.g., the computing system 102 of the electric work vehicle 10, the computing system 116 of the transport vehicle 114, the computing system 128 of the electrolyzer(s) 126, and/or the computing system 138 of the charging trailer 144) may analyze the data received at (210) to determine the location(s) of the electric work vehicle(s) 10 being used at the work site (e.g., the work site 177), such as relative to the charging trailer 144. As will be described below, the determined location(s) of the electric work vehicle(s) 10 is used in coordinating the operation of one or more components of the charging system 100.

Furthermore, at (214), the method 200 includes receiving charging trailer energy storage device data. For instance, as described above, the energy storage device monitoring system 150 of the charging trailer 144 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138 of the charging trailer 144). In this respect, during operation of the charging system 100, such computing system(s) may receive data energy storage device monitoring system 150. Such data may, in turn, be indicative of the charging status of the energy storage device 199 of the charging trailer 144.

Additionally, at (216), the method 200 includes determining the charge status of the charging trailer energy storage device. For instance, the one or more computing systems of the charging system 100 (e.g., the computing system 102 of the electric work vehicle 10, the computing system 116 of the transport vehicle 114, the computing system 128 of the electrolyzer(s) 126, and/or the computing system 138 of the charging trailer 144) may analyze the data received at (214) to determine charging status of the energy storage device 199 of the charging trailer 144. As will be described below, the determined charging status of the energy storage device 199 of the charging trailer 144 is used in coordinating the operation of one or more components of the charging system 100.

Moreover, at (218), the method 200 includes controlling the operation of the electrolyzer(s). For instance, as described above, the control device(s) 136 of the electrolyzer(s) 126 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138 of the charging trailer 144). In this respect, such computing system(s) may be configured to control the operation the control device(s) 136 to ensure that the electrolyzer(s) 126 produces sufficient hydrogen to support the operation being performed at the work site. For example, such computing system(s) may be configured to control the operation the control device(s) 136 based on the amount of hydrogen determined at (204), the electric work vehicle charging status(es) determined at (208), the electric work vehicle location(s) determined at (212), and/or the charging status of the energy storage device(s) 199 of the charging trailer 114. Additional parameters, such as the cost of electricity from the power grid (e.g., the power grid 170), may be used as well.

In addition, at (220), the method 200 includes controlling the operation of the transport vehicle(s). For instance, one or more components (e.g., a navigation system, an autonomous driving system, etc.) of the transport vehicle(s) 114 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138 of the charging trailer 144). In this respect, such computing system(s) may be configured to control the operation the component(s) of the transport vehicle(s) 114 to ensure sufficient hydrogen is provided to the charging trailer 144 to support the operation being performed at the work site. For example, such computing system(s) may be configured to control the operation the component(s) of the transport vehicle(s) 114 based on the amount of hydrogen determined at (204), the electric work vehicle charging status(es) determined at (208), the electric work vehicle location(s) determined at (212), and/or the charging status of the energy storage device(s) 199 of the charging trailer 114. Additional parameters, such as the cost of electricity from the power grid (e.g., the power grid 170), may be used as well.

As shown in FIG. 4, at (222), the method 200 includes controlling the operation of the charging trailer. For instance, as described above, the control device(s) 148 of the charging trailer 144 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138 of the charging trailer 144). In this respect, such computing system(s) may be configured to control the operation the control device(s) 144 to ensure that fuel cell(s) 190 of the charging trailer 144 produce sufficient electricity to support the operation being performed at the work site. For example, such computing system(s) may be configured to control the operation the control device(s) 148 based on the amount of hydrogen determined at (204), the electric work vehicle charging status(es) determined at (208), the electric work vehicle location(s) determined at (212), and/or the charging status of the energy storage device(s) 199 of the charging trailer 114. Additional parameters, such as the cost of electricity from the power grid (e.g., the power grid 170), may be used as well.

Furthermore, at (224), the method 200 includes controlling the operation of the electric work vehicle(s). For instance, one or more components (e.g., a navigation system, an autonomous driving system, etc.) of the electric work vehicle(s) 10 may be communicatively coupled to one or more computing systems of the charging system 100 (e.g., one or more of the computing system 102 of the electric work vehicle 10, the computing system 116 of the transport vehicle 114, the computing system 128 of the electrolyzer(s) 126, and/or the computing system 138 of the charging trailer 144). In this respect, such computing system(s) may be configured to control the operation the component(s) of the electric work vehicle(s) 10 to ensure that the battery module(s) 80 of the electric work vehicle(s) 10 is sufficiently charged to support the operation being performed at the work site. For example, such computing system(s) may be configured to control the operation the component(s) of the transport vehicle(s) 114 based on the amount of hydrogen determined at (204), the electric work vehicle charging status(es) determined at (208), the electric work vehicle location(s) determined at (212), and/or the charging status of the energy storage device(s) 199 of the charging trailer 114. Additional parameters, such as the cost of electricity from the power grid (e.g., the power grid 170), may be used as well. Such control of the electric work vehicle(s) 10 may include determining when each electric vehicle 10 should move to the charging trailer 144 for charging and/or the route along which each electric work vehicle(s) 10 should travel to move to the charging trailer 144.

It is to be understood that the steps of the method 200 are performed by one or more of the computing systems 102, 116, 128, 138 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system(s) 102, 116, 128, 138 described herein, such as the method 200, is implemented in software code or instructions which are tangibly stored on a tangible computer readable medium. The c computing system(s) 102, 116, 128, 138 loads the software code or instructions via a direct interface with the computer readable medium or via a wired and/or wireless network. Upon loading and executing such software code or instructions by the computing system(s) 102, 116, 128, 138, the computing system(s) 102, 116, 128, 138 may perform any of the functionality of the computing system(s) 102, 116, 128, 138 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A charging system, comprising:
a charging trailer including:
a fuel cell configured to generate electricity from received hydrogen; and
a charger configured to charge a battery of an electric work vehicle using the electricity generated by the fuel cell; and
a computing system configured to control an operation of the fuel cell based at least in part on a charging status of the electric work vehicle.
